(19) United States
(12) Patent Application Publication
(10) Pub. No.: US 2013/0064512 A1
(43) Pub. Date: Mar. 14, 2013

(54) COOLING SYSTEM FOR AN OPTICAL MODULE

(71) Applicant: Nayana GHANTIWALA, San Jose, CA (US)

(72) Inventor: Nayana GHANTIWALA, San Jose, CA (US)

(21) Appl. No.: 13/228,350

(22) Filed: Sep. 8, 2011

(51) Int. Cl. G02B 6/36

(52) U.S. Cl. 385/92

(57) ABSTRACT

An optical module with a cooling system provides enhanced heat removal using one or more passive cooling devices. Such passive cooling devices include a protrusion through the housing of the optical module that thermally couples a heat-generating component in the optical module to a heat-sink module; a PGS material configured to form wetted contact with adjacent surfaces and therefore provide greater thermal conductivity; and one or more heat pipes configured to thermally couple a heat-generating component in the optical module to a remote heat-sink.

### BACKGROUND OF THE INVENTION

1. Field of the Invention

Embodiments of the present invention relate generally to optical communication systems, and, more specifically, to a cooling system for an optical module.

2. Description of the Related Art

Since the inception of the Internet, steady growth in Internet data traffic has taken place and will likely continue to take place for the foreseeable future. Consequently, expanding the capacity of the optical communication systems that are the backbone of the Internet is a continuing and important goal. Because the installation of new and/or additional optical fiber is generally an expensive and time-consuming undertaking, increasing the data rate for existing optical fibers is a preferred approach for satisfying the ever-greater demand for Internet data traffic capacity.

One way in which the data rate for existing optical fibers can be increased is by upgrading the performance of optical modules used in the optical communication system, such as wavelength selective switches (WSSs), optical amplifiers, optical add-drop multiplexers (OADMs), and the like. Such optical modules are typically configured as removable elements in an optical communication system and are much more easily replaced and installed than optical fibers. Replacing such optical modules with higher performance modules can provide an optical communication system with improved transmission rate, range, and other features without installing additional optical fibers. However, higher performance optical modules generally have substantially greater power consumption and therefore must reject more heat to prevent overheating during operation, even while having the same form-factor constraints as lower-power modules.

Consequently, as the demand for higher-capacity optical communication systems continues to increase, there is a need in the art for improving the cooling of optical modules used in such systems.

### SUMMARY OF THE INVENTION

Embodiments of the invention set forth an optical module with a cooling system that provides enhanced heat removal using one or more passive cooling devices. Passive cooling devices contemplated by embodiments of the invention include a protrusion through the housing of the optical module that thermally couples a heat-generating component in the optical module to a heat-sink module; a PGS material configured to form wetted contact with adjacent surfaces and therefore provide greater thermal conductivity; and one or more heat pipes configured to thermally couple a heat-generating component in the optical module to a remote heat-sink.

According to one embodiment of the invention, an optical component package comprises a heat-generating component, a heat sink sheet, a heat sink module, a first wetting film interposed between the heat sink sheet and the heat-generating component, and a second wetting film interposed between the heat sink sheet and the heat sink module.

According to another embodiment of the invention, an optical module comprises one or more optical components, a protective enclosure for the optical components having an opening aligned with a heat generating component disposed in the protective enclosure, and a heat sink module protruding through the opening to be in thermal contact with the heat generating optical component.

According to another embodiment of the invention, an optical module with a cooling system comprises an optical module having a protective enclosure and at least one heat-generating components housed in the protective enclosure, a heat sink sheet, a heat sink module, a first wetting film interposed between the heat sink sheet and the at least one heat-generating component, and a second wetting film interposed between the heat sink sheet and the heat sink module.

According to yet another embodiment of the invention, an optical module is mounted on a line card, has a smaller footprint than the line card, and comprises a heat-generating component, a heat sink disposed within a footprint of the line card and extending beyond a footprint of the optical module, and heat pipes for transferring heat from the heat-generating component to the heat sink.

### BRIEF DESCRIPTION OF THE DRAWINGS

FIG. 1 schematically illustrates a perspective view of an optical module configured according to an embodiment of the invention.

FIG. 2 schematically illustrates a cross-sectional view of an optical module, a top cover, and a heat sink module, configured according to an embodiment of the invention.

FIG. 3 is an expanded view of a region indicated in FIG. 2.

FIG. 4 schematically illustrates a cross-sectional view of an optical module with a heat sink module that has multiple protrusions, according to an embodiment of the invention.

FIG. 5 illustrates a cross-sectional view of an optical module mounted on a PCB line card and configured with one or more heat pipes and a remote heat sink, according to an embodiment of the invention.

### DETAILED DESCRIPTION

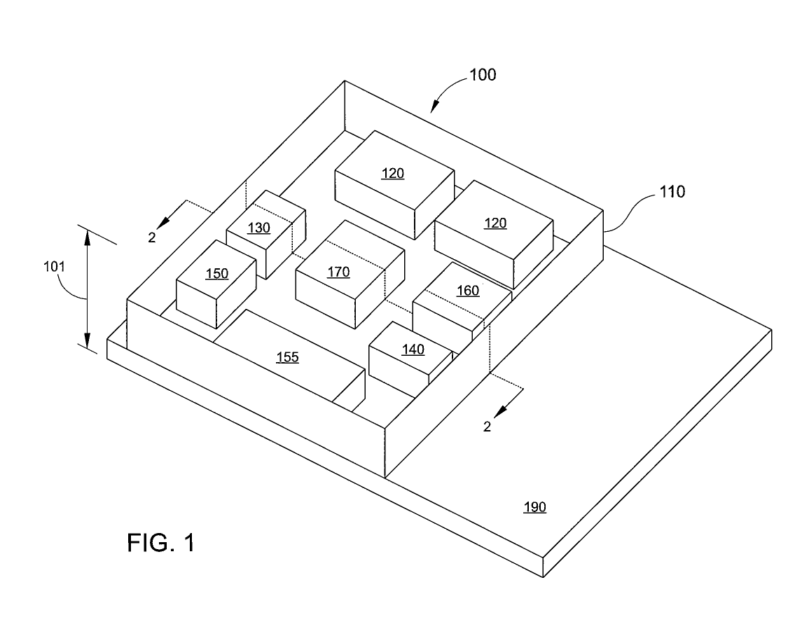

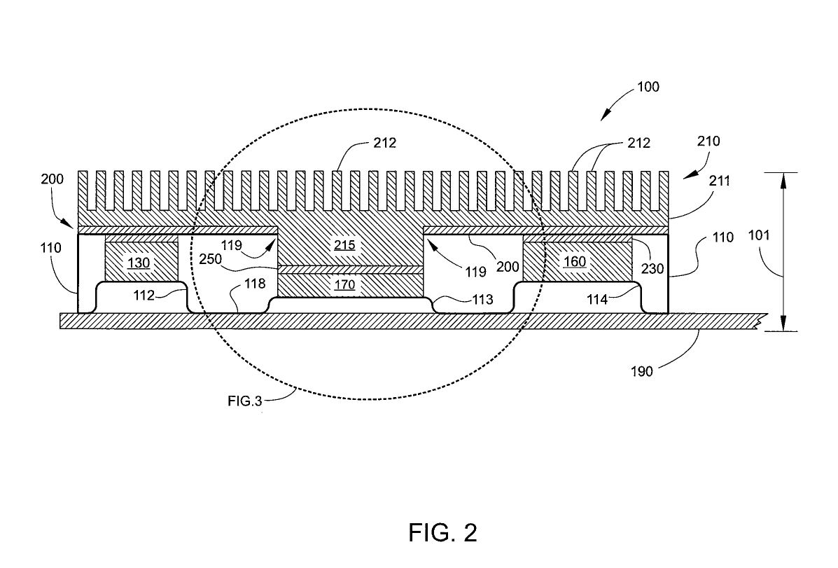

FIG. 1 schematically illustrates a perspective view of an optical module 100 configured according to an embodiment of the invention. Optical module 100 may be configured as any optical module used in optical telecommunications and data communications equipment that provides optical-to-electrical conversion of signals and vice versa, wavelength selective routing of channels, amplification or attenuation of channels, and the like. For example, optical module 100 may be configured as a wavelength selective switch, an optical add-drop multiplexer, an optical amplifier, a transponder, etc. As such, optical module 100 is mounted to a printed circuit board (PCB) line card 190 and is configured with dimensions compatible with a standard line card slot size. For example, in one embodiment, PCB line card 190 has a footprint of 13 to 17 in×8 to 11 in, and a height 101 of optical module 100 and PCB line card 190 is no more than 2.4 in, i.e., the width of two standard line card slots. In another embodiment, line card height 101 of optical module 100 and line card 190 is no more than 2.0 in, for compatibility with a narrower line card slot width. It is noted that height 101 includes the height of a top cover 201 and a heat sink module 210, which are shown in FIG. 2. For clarity, optical module 100 is illustrated in FIG. 1 without top cover 200 or heat sink module 210.

Optical module 100 includes one or more heat-generating components and optical components disposed inside a housing 110, where housing 110 acts as a protective enclosure for the heat-generating and optical components. In the embodiment illustrated in FIG. 1, optical module 100 is configured as a transponder for receiving, amplifying, and retransmitting wavelength-division multiplexed (WDM) signals. In such an embodiment, optical module 110 includes laser packages 120, a multiplexer/demultiplexer (MUX) 130, a receiver 140, modulator driver chips 150, a modulator 155, a field-programmable gate array (FPGA) 160 and an application-specific integrated circuit (ASIC) 170, as well as other electronic and optical components.

Housing 110 comprises a metallic enclosure configured to protect the optical and electronic components of optical module 100 from dust, contamination, and mechanical damage. In some embodiments, housing 110 is substantially sealed using any technically feasible apparatus or treatment, such as welded or soldered panels, o-rings, gaskets, and/or other elastomeric sealing members. Laser packages 120 include integrated tunable laser assemblies (ITLAs) or other types of laser assemblies suitable for use in a WDM system transponder. MUX 130 multiplexes and de-multiplexes WDM signals fed into optical module 100. Receiver 140 receives the WDM signals fed into optical module 100, modulator driver chips 150 control modulator 155, and FPGA 160 performs the control, calibration, and communication processes for normal operation of optical module 100. ASIC 170 includes a specialized microprocessor, such as a digital signal processor (DSP), having an architecture optimized for performing the very large number of mathematical operations required for digital signal processing of 40 gigabit Ethernet (40 GbE) and 100 GbE signals.

As is well-known in the art, during normal operation of optical module 100, laser assemblies 120, MUX 130, receiver 140, modulator driver chips 150, modulator 155, FPGA 160 and ASIC 170 are each significant sources of heat. For example, in performing calculation-intensive algorithms associated with digital signal processing, ASIC 170 may have high heat-output, e.g., 30-50 W or more. Laser packages 120 generally generate 5-10 W of heat during operation. Similarly, MUX 130, receiver 140, modulator driver chips 150, modulator 155, and FPGA 160 may also serve as significant sources of heat inside housing 110. All told, as a state-of-the-art optical module configured for 40 GbE or 100 GbE signals, optical module 100 may have a total thermal budget of 80 W or more while having the same space and heat-elimination restrictions as optical modules with half the thermal budget. For example, optical module 100 may be specified to operate with only passive cooling technologies, and therefore cannot rely on an internal fan or other active cooling devices to remove the desired quantity of thermal energy from housing 110.

Because numerous electronic and optical components in housing 110 can suffer degraded performance or even damage when exposed to high temperatures, optical module 100 includes heat sink module 210, which is illustrated in FIG. 2. Such heat-sensitive components of optical module 100 include the laser diodes of laser packages 120 and the integrated circuits of MUX 130, receiver 140, modulator driver chips 150, modulator 155, FPGA 160 and ASIC 170.

FIG. 2 schematically illustrates a cross-sectional view of optical module 100, top cover 200, and heat sink module 210, configured according to an embodiment of the invention. The cross-sectional view illustrated in FIG. 2 is taken at section 2-2 in FIG. 1. As shown, top cover 200 makes up the top surface of housing 110 and heat sink module 210 is mounted on top cover 200. Optical and electrical components of optical module 100 are disposed on support protrusions to ensure precise vertical positioning of said components inside housing 110. In FIG. 2, MUX 130, ASIC 170, and FPGA 160 are disposed on support protrusions 112, 113, and 114, respectively. Support protrusions 112, 113, and 114 may be formed in the bottom surface 118 of housing 110 and are each configured such that the heat-generating component being supported, e.g., MUX 130, ASIC 170, or FPGA 160, is positioned a desired distance from top cover 200. A thermal interface material (TIM) 230 is interposed between said heat-generating components of optical module 100 and top cover 200 to fill the gap formed therebetween. In some embodiments, TIM 230 may also be disposed between top cover 200 and heat sink module 210. TIM 230 is described in greater detail below.

It is noted that the terms “top” and “bottom,” as used herein, are for ease of description, and are not intended to limit the orientation of optical module 100 or the scope of the invention. One of skill in the art will readily appreciate that the physical orientation of an optical-electrical device, such as optical module 100, may be positioned in any orientation without affecting the operation or performance thereof.

Top cover 200 is a component of housing 110 and is constructed of materials similar to materials comprising housing 110. In some embodiments, top cover 200 is removably attached to housing 110 to facilitate access to the electronic and optical components disposed therein for service, maintenance, replacement, etc. In such embodiments, top cover 200 may form a sealed contact with housing 110 via an O-ring, gasket, or other sealing material, to protect the components of optical module 100 from dust and other contamination. In the embodiment illustrated in FIG. 2, top cover 200 includes an opening 119 that is substantially aligned with ASIC 170. In other embodiments, top cover 200 includes multiple openings similar to opening 119 that are aligned with one or more heat-generating components disposed in housing 110, e.g., laser packages 120, MUX 130, receiver 140, modulator driver chips 150, modulator 155, and/or FPGA 160. In order to minimize entry of unwanted dust and other particle contamination into housing 110, opening 119 may be configured to be a sealed opening when protrusion 215 is disposed therein. Any technically feasible apparatus or treatment may be used to seal opening 110, such as welding or soldering, o-rings, gaskets, and/or other elastomeric sealing members.

Heat sink module 210 includes a base 211, a plurality of cooling fins 212, and a protrusion 215. Cooling fins 212 are coupled to base 211 and are configured to increase the surface area of heat sink module 210 and thereby facilitate greater heat transfer capacity in heat sink module 210. In some embodiments, base 211 and cooling fins 212 may be formed from a single block of thermally conductive metal, e.g., copper or aluminum. Base 211 is mechanically mounted and thermally coupled to top cover 200. In one embodiment, base 211 and top cover 200 are formed as a single component or assembly, so that base 211 of heat sink module 210 also serves as top cover 200. In some embodiments, base 211 is removably mounted to top cover 200 via threaded fasteners, clamps, or any other technically feasible apparatus that allows base 211 to be attached to and removed from top cover 200 as desired. In such embodiments, base 211 is thermally coupled to top cover 200 with TIM 230 that is disposed between top cover 200 and base 211.

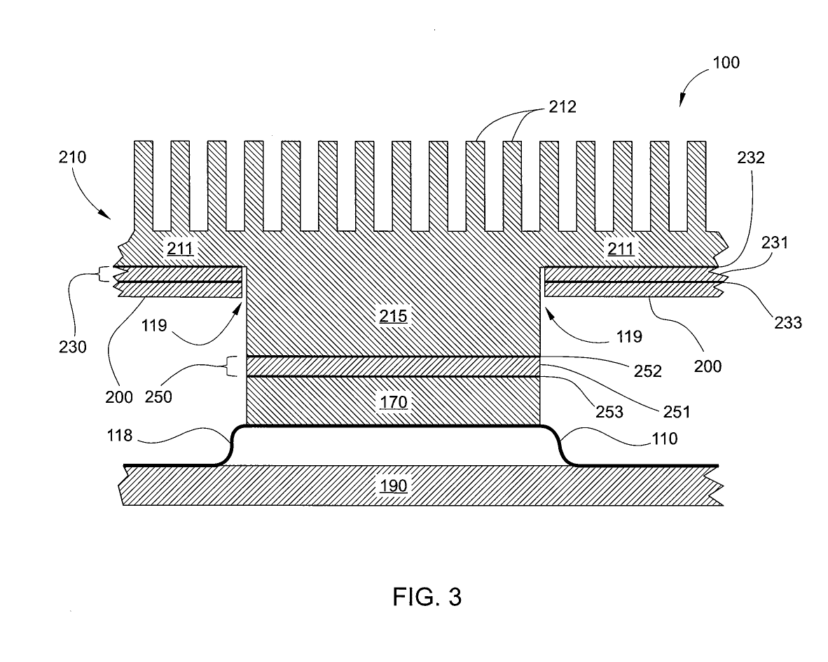

TIM 230 is a thin layer of thermally conductive material configured to maximize conductive heat transfer between top cover 200 and base 211. Suitable materials for TIM 230 include thermally conductive gels, thermal greases, solders, or a thermally conductive sheet, such as a mechanically compressible gap pad. In a preferred embodiment, TIM 230 comprises a heat sink sheet, such as a pyrolytic graphite sheet (PGS) 231, shown in FIG. 3. FIG. 3 is an expanded view of the region indicated in FIG. 2. PGS 231 is a heat sink sheet formed from pyrolytic carbon, which is a man-made material similar to graphite. PGS 231 is flexible, can be cut into custom shapes, and has very high thermal conductivity, i.e., two to four times as high as copper and three to six times as high as aluminum. In addition, PGS 231 facilitates disassembly of optical module 100 for reworking or service, unlike solders and thermal epoxies. PGS 231 is not limited to a specific thickness, but PGS 231 is generally available in thin sheets of various standard thicknesses, e.g., 25 microns, 70 microns, 100 microns, etc.

In one embodiment, PGS 231 includes a wetting film 232 on the top surface of TIM 230 that contacts base 211 and a wetting film 233 on the bottom surface of TIM 230 that contacts top cover 200. Wetting films 232, 233 are illustrated in FIG. 3. Wetting film 232 provides wetted contact between base 211 and PGS 231, and wetting film 233 provides wetted contact between PGS 231 and top cover 200. As used herein, “wetted contact” is defined as contact of a hard, dry surface with a material that substantially conforms to the hard, dry surface, and does not imply contact of the surface with a liquid. In contrast to dry contact between two dry, hard surfaces, the wetted contact formed by wetting films 232, 233 facilitates high thermal conductivity between adjacent hard, dry surfaces. Wetting films 232, 233 are selected from materials that conform to the adjacent surfaces, thereby producing much greater contact area compared to the contact area associated with dry contact between the same adjacent surfaces. This is because the contact area associated with dry contact between two dry, hard surfaces is generally only point contact at a few discrete locations. As one of skill in the art will readily appreciate, the increased contact area formed by wetting films 232, 233 results in much higher conductive heat transfer between said surfaces.

In some embodiments, wetting films 232, 233 are adhesive films deposited or applied to PGS 231 prior to the assembly of optical module 100. In such embodiments, wetting films 232, 233 are preferably very thin, e.g., five to ten microns. This is because adhesive materials suitable for use as wetting films 232, 233, generally have low thermal conductivity; when wetting films 232, 233 are thicker, heat transfer is reduced and the benefit of producing wet contact between the two surfaces is partially negated. One of skill in the art will appreciate that use of wetting films 232, 233 that are greater than 20 microns in thickness can significantly reduce thermal conductivity of optical module 100 for rejecting heat from heat-generating components disposed therein. An added benefit of configuring PGS 231 with wetting films 232, 233 that are adhesive films is that PGS 231 is less likely to generate particles of pryolytic graphite over the operating life of optical module 100. In this way, the potential for particle contamination being formed in and around housing 110 is substantially reduced.

Protrusion 215 is a portion of heat sink module 210 configured to extend from base 211 into opening 119 in top cover 200, as shown in FIGS. 2 and 3. In some embodiments, protrusion 215 and base 211 are formed from a single block of highly thermally conductive metal, e.g., copper or aluminum. Protrusion 215 is in thermal contact with ASIC 170 via a TIM 250. One of skill in the art will appreciate that the embodiment illustrated in FIGS. 2 and 3 is an exemplary embodiment. In other embodiments, protrusion 215 and opening 119 may configured so that protrusion 215 is in thermal contact with a different heat-generating component of optical module 100. In the embodiment illustrated in FIGS. 2 and 3, protrusion 215 is in thermal contact with the component of optical module 100 that generates the most heat, i.e., ASIC 170. In other embodiments, protrusion 215 is configured to be in thermal contact with a heat-generating component of optical module 100 that does not generate the most heat, but is positioned relative to other components of optical module in such a way that increased heat removal from said heat-generating component is desirable.

Materials suitable for use as TIM 250 are substantially similar to the materials suitable for use as TIM 230. In a preferred embodiment, TIM 250 comprises a PGS 251 with a wetting film 252 on the top surface of TIM 250 that contacts protrusion 215 and a wetting film 253 on the bottom surface of TIM 250 that contacts support protrusion 113. Wetting films 252, 253 provide the wetted contact described above that facilitates high thermal conductivity between protrusion 215 and ASIC 170. In this way, a thermally conductive path between ASIC 170 and heat sink module 210 is formed that has high thermal conductivity, even though ASIC 170 is enclosed in housing 110. In contrast, heat-generating components of prior art optical modules are typically separated from a heat sink module by a top cover and one or more gap pads. Conventional gap pads are relatively thick compared to PGS 251; gap pads are generally several hundred microns or more in thickness while most PGSs are 100 microns in thickness or less. In addition, the thermal conductivity of PGS 251 is on the order of 1000 times higher than the thermal conductivity of conventional gap pad material. Taken together, the greater thickness and dramatically lower thermal conductivity of conventional gaps pads results in a thermally conductive path that does not allow sufficient conductive heat transfer from the optical module when the optical module includes higher-power, state-of-the-art components.

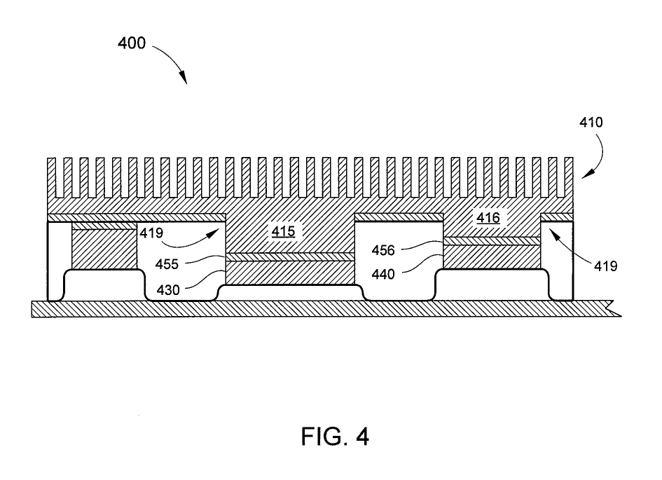

In one embodiment, a heat sink module includes multiple protrusions that are configured to extend through one or more openings in a top cover of an optical module. In such an embodiment, the protrusions are aligned with and contact multiple heat-generating components disposed in the optical module so that heat transfer from the multiple heat-generating components is significantly enhanced. FIG. 4 schematically illustrates a cross-sectional view of an optical module 400 with a heat sink module 410 that has multiple protrusions, according to an embodiment of the invention. As shown, heat sink module 410 includes protrusions 415, 416 that extend through openings 419 and are in thermal contact with heat-generating components 430, 440, respectively via TIM 455, 456 respectively. In such an embodiment, the thickness of TIM 455 may be significantly different than the thickness of TIM 456. This is because the precise positioning of heat-generating component 430 with respect to protrusion 455 and the precise positioning of heat-generating component 440 to protrusion 456 is problematic; tolerance stacking typically results in a different-sized gap between heat-generating component 430 and protrusion 455 than the gap between heat-generating component 440 and protrusion 456.

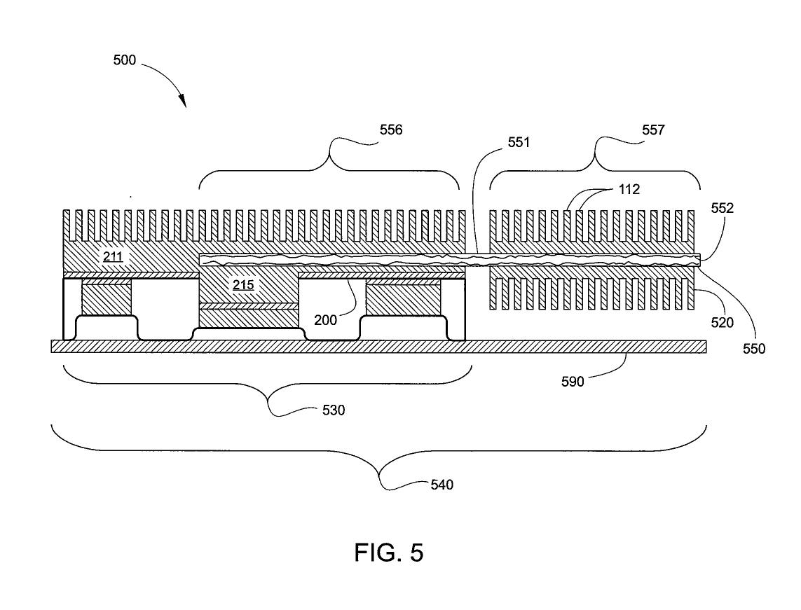

FIG. 5 illustrates a cross-sectional view of an optical module 500 mounted on a PCB line card 590 and configured with one or more heat pipes 550 and a remote heat sink 520, according to an embodiment of the invention. Optical module 550 is otherwise similar in organization and operation to optical module 100 in FIGS. 1-3. Heat transfer from optical module 500 is enhanced via heat pipe 550, which is configured to transfer heat from housing 110 to remote heat sink 520. Heat sink 520 extends beyond a footprint 530 of optical module 500 over a portion of footprint 540 of PCB line card 590, thereby increasing the total number and surface area of cooling fins 212 used to remove heat from optical module 500.

Heat pipe 550 is a passive heat transfer device that includes a tube 551 formed from a highly thermally conductive metal, such as a copper or aluminum. Heat pipe 550 further includes a capillary wicking material 552 and a quantity of working fluid, such as water, acetone, methanol, and the like. Heat absorbed by heat pipe 550 from protrusion 215, base 211, and top cover 200 vaporizes the working fluid in an evaporator portion 556 of heat pipe 550. The vaporized working fluid transports heat to a condenser portion 557, i.e., the portion of heat pipe 550 in contact with remote heat sink 520. Vapor in condenser portion 557 condenses to release heat to a cooling medium, such as air flowing over remote heat sink 520. Capillary wicking material 552 returns condensed working fluid to evaporator portion 556.

In the embodiment illustrated in FIG. 5, heat pipe 550 is configured to remove heat primarily from a heat-generating component of optical module 500 that is thermally coupled to protrusion 215. In other embodiments, one or more heat pipes 550 are used to transport heat from portions of top cover 200 rather than from protrusion 215. In some embodiments, a PGS sheet is disposed between heat pipe 550 and adjacent surfaces to enhance heat transfer from said surfaces. Such adjacent surfaces include surfaces of top cover 200, housing 110 and base 211.

In sum, embodiments of the invention set forth an optical module with a cooling system that provides enhanced heat removal using one or more passive cooling devices. Advantages of the invention include greater heat transfer from an optical module as well as the ability to enhance heat transfer from one or more specific heat-generating components in the optical module.

While the foregoing is directed to embodiments of the present invention, other and further embodiments of the invention may be devised without departing from the basic scope thereof, and the scope thereof is determined by the claims that follow.

We claim:

1. An optical component package comprising:
a heat-generating component;
a heat sink module;
a heat sink sheet interposed between the heat-generating component and the heat sink module;
a first wetting film interposed between the heat sink sheet and the heat-generating component; and
a second wetting film interposed between the heat sink sheet and the heat sink module.

2. The optical component package of claim 1, wherein the heat-generating component comprises a digital signal processor, an application specific integrated circuit, a field-programmable gate array, a laser package, or a wavelength-division multiplexer.

3. The optical component package of claim 1, further comprising a protective enclosure that contains the heat-generating component and at least one optical component.

4. The optical component package of claim 1, wherein the heat sink sheet comprises a pyrolytic graphite sheet.

5. The optical component package of claim 1, wherein at least one of the first wetting film and the second wetting film has a thickness that is less than about 20 microns.

6. The optical component package of claim 1, wherein at least one of the first wetting film and the second wetting film comprises an adhesive film deposited on the heat sink sheet.

7. The optical component package of claim 1, wherein the heat sink module includes a protrusion that is disposed in an opening in a protective enclosure containing the heat-generating component and is in thermal contact with the heat-generating component via the heat sink sheet.

8. The optical component package of claim 1, wherein the heat sink module includes a heat pipe thermally coupled to a remote heat sink.

9. An optical module comprising:
one or more optical components;
a protective enclosure for the optical components having an opening aligned with a heat-generating component disposed in the protective enclosure; and
a heat sink module protruding through the opening to be in thermal contact with the heat-generating component.

10. The optical component package of claim 9, wherein thermal contact with the heat-generating component is via a heat sink sheet interposed between the heat sink module and the heat-generating component and having a first wetting film interposed between the heat sink sheet and the heat-generating component and a second wetting film interposed between the heat sink sheet and the heat sink module.

11. The optical component package of claim 10, wherein the heat sink sheet comprises a pyrolytic graphite sheet.

12. The optical component package of claim 10, wherein at least one of the first wetting film and the second wetting film has a thickness that is less than about 20 microns.

13. The optical component package of claim 10, wherein at least one of the first wetting film and the second wetting film comprises an adhesive film deposited on the heat sink sheet.

14. The optical component package of claim 9, wherein the heat sink module includes a heat pipe thermally coupled to a remote heat sink.

15. An optical module with a cooling system, comprising:
an optical module having a protective enclosure and at least one heat-generating component housed in the protective enclosure;
a heat sink sheet;
a heat sink module;
a first wetting film interposed between the heat sink sheet and the at least one heat-generating component; and
a second wetting film interposed between the heat sink sheet and the heat sink module.

16. The optical component package of claim 15, wherein at least one of the first wetting film and the second wetting film comprises an adhesive film deposited on the heat sink sheet.

17. The optical component package of claim 15, wherein at least one of the first wetting film and the second wetting film has a thickness that is less than about 20 microns.

18. The optical component package of claim 15, wherein the heat sink sheet comprises a pyrolytic graphite sheet.

19. The optical component package of claim 15, wherein the heat sink module includes a protrusion that is disposed in an opening in the protective enclosure and is in thermal contact with the heat-generating component via the heat sink sheet.

20. The optical component package of claim 15, wherein the heat sink module includes a heat pipe thermally coupled to a remote heat sink.

21. An optical module mounted on a line card, the optical module having a smaller footprint than the line card, the optical module comprising:
a heat-generating component;
a heat sink disposed within a footprint of the line card and extending beyond a footprint of the optical module; and
a heat pipe for transferring heat from the heat-generating component to the heat sink.

22. The optical component package of claim 21, wherein the heat pipe transfers heat from the heat-generating component via a protrusion from the heat sink that is disposed in an opening in a protective enclosure containing the heat-generating component and is in thermal contact with the heat-generating component.

23. The optical component package of claim 22, wherein the thermal contact with the heat-generating component is via a heat sink sheet that is interposed between the protrusion and the heat-generating component and has a first wetting film interposed between the heat sink sheet and the heat-generating component and a second wetting film interposed between the heat sink sheet and the protrusion.

24. The optical component package of claim 23, wherein the heat sink sheet comprises a pyrolytic graphite sheet.

25. The optical component package of claim 21, wherein a portion of the heat sink extending beyond the footprint of the optical module comprises a remote heat sink.
